(19) United States
(12) Patent Application Publication
(10) Pub. No.: US 2016/0036046 A1
(43) Pub. Date: Feb. 4, 2016

(54) LITHIUM ION SECONDARY BATTERY

(71) Applicant: TOYOTA JIDOSHA KABUSHIKI KAISHA, Toyota-shi (JP)

(72) Inventor: Yoshitomo TAKEBAYASHI, Toyota-shi (JP)

(73) Assignee: TOYOTA JIDOSHA KABUSHIKI KAISHA, Toyota-shi (JP)

(21) Appl. No.: 14/816,294

(22) Filed: Aug. 3, 2015

(30) Foreign Application Priority Data
Aug. 4, 2014 (JP) 2014-158595

(51) Int. Cl. H01M 4/36; H01M 10/0525; H01M 4/505; H01M 4/58; H01M 4/525

(52) U.S. Cl. CPC H01M 4/364; H01M 4/5825; H01M 4/525; H01M 4/505; H01M 10/0525; H01M 2004/028

(57) ABSTRACT

A lithium ion secondary battery includes a positive electrode that includes a positive electrode active material layer; a negative electrode that includes a negative electrode active material layer; and a nonaqueous electrolyte. The positive electrode active material layer contains an inorganic phosphate compound and a high-potential positive electrode active material that causes an open-circuit voltage to be 4.3 V or higher with respect to lithium metal. The inorganic phosphate compound is a compound containing at least one hydrogen atom in a chemical formula.

### INCORPORATION BY REFERENCE

The disclosure of Japanese Patent Application No. 2014-158595 filed on Aug. 4, 2014 including the specification, drawings and abstract is incorporated herein by reference in its entirety.

### BACKGROUND OF THE INVENTION

1. Field of the Invention

The present invention relates to a lithium ion secondary battery.

2. Description of Related Art

Recently, a lithium ion secondary battery has been used as a motor-driving power supply or an auxiliary power supply for an electric vehicle, a hybrid electric vehicle, or a fuel cell vehicle. Therefore, high output and long life performance at high cycle are required of the battery.

In order to realize high output, it is necessary to increase the voltage of a battery that is used (to increase the upper limit voltage during use). In order to increase the voltage, for example, the use of a high-potential positive electrode active material (typically, a lithium transition metal compound) as a positive electrode active material is considered, the high-potential positive electrode active material being capable of suitably functioning as a positive electrode active material when a lithium ion secondary battery is charged to a potential (for example, a positive electrode potential of 4.3 V or higher (vs. Li/Li⁺)) which is higher than the upper limit voltage of a general lithium ion secondary battery in a typical use mode.

However, in a lithium ion secondary battery which realizes the above-described high-voltage state in which an open-circuit voltage (OCV; also referred to as “open-circuit potential”) is 4.3 V or higher (vs. Li/Li⁺), the oxidation decomposition of a nonaqueous electrolyte (nonaqueous electrolytic solution) is promoted in a high voltage state depending on the kind of the nonaqueous electrolyte that is used, and an acid (typically, hydrogen fluoride; HF) is produced in the electrolyte. Further, the produced acid may cause the elution of a transition metal component in the positive electrode active material, which may lead to capacity deterioration.

In order to solve the problem, Japanese Patent Application Publication No. 2014-103098 (JP 2014-103098 A) discloses a nonaqueous electrolyte secondary battery which realizes a high-voltage state in which an open-circuit potential (OCV) is 4.3 V or higher (vs. Li/Li⁺). This nonaqueous electrolyte secondary battery includes a positive electrode active material layer that contains a phosphate and/or a pyrophosphate containing an alkali metal or a Group 2 element. In the technique disclosed in JP 2014-103098 A, the phosphate and/or the pyrophosphate functions as an acid consuming material and thus reacts with an acid (typically, HF as described above) produced in the nonaqueous electrolytic solution such that the elution of transition metal in the positive electrode active material is suppressed, and capacity deterioration caused by the elution of transition metal is suppressed.

With the technique disclosed in JP 2014-103098 A, it is possible to obtain a nonaqueous electrolyte secondary battery in which capacity deterioration is suppressed and which operates with a high output. However, in the nonaqueous electrolyte secondary battery which operates with a high output, the oxidation decomposition of a nonaqueous electrolytic solution may be promoted to produce a large amount of acid. Therefore, with the phosphate and/or the pyrophosphate containing an alkali metal or a Group 2 element, the consumption of an acid per unit molar amount of the phosphate and/or the pyrophosphate added is not sufficient, and there is room for improvement from the viewpoint of suppressing capacity deterioration.

### SUMMARY OF THE INVENTION

The invention provides a lithium ion secondary battery in which a high-potential positive electrode active material that causes an open-circuit potential (OCV) to be 4.3 V or higher (vs. Li/Li+) is used under high-voltage conditions, the battery being configured to suppress capacity deterioration which is caused by the elution of transition metal from the high-potential positive electrode active material due to an acid produced by the decomposition of a nonaqueous electrolyte (nonaqueous electrolytic solution), and the battery having good cycle characteristics.

An aspect of the invention relates to a lithium ion secondary battery including a positive electrode that includes a positive electrode active material layer; a negative electrode that includes a negative electrode active material layer; and a nonaqueous electrolyte. The positive electrode active material layer contains an inorganic phosphate compound and a high-potential positive electrode active material that causes an open-circuit voltage (OCV) to be 4.3 V or higher with respect to lithium metal (vs. Li/Li+). The inorganic phosphate compound is a compound containing at least one hydrogen atom in a chemical formula.

According to the above-described configuration, a hydrogen atom is highly reactive with an acid, and thus the consumption of an acid in the electrolyte per unit molar amount of the added inorganic phosphate compound can be increased. Accordingly, the positive electrode active material layer contains a relatively small amount of the inorganic phosphate compound. Thus, the elution of transition metal from the positive electrode active material can be effectively suppressed, and capacity deterioration caused by the elution of transition metal can be suppressed. According to the aspect of the invention, it is possible to improve cycle characteristics of the lithium ion secondary battery which is used at a voltage value (an open-circuit potential of 4.3 V or higher (vs. Li/Li⁺)) higher than the voltage value of a conventional general lithium ion secondary battery.

In the above-described aspect, the inorganic phosphate compound may consist of only non-metal elements. In the lithium ion secondary battery having the above-described configuration, a different metal element (ion) derived from the inorganic phosphate compound is not introduced into the positive electrode active material layer, and even when the lithium ion secondary battery is in a high-voltage state (in a state in which an open-circuit potential is 4.3 V or higher (vs. Li/Li⁺)), an acid produced in the nonaqueous electrolyte can be effectively consumed. Thus, in the lithium ion secondary battery having the above-described configuration, there is no influence caused by the introduction of a different metal (ion) derived from the inorganic phosphate compound into the positive electrode active material layer, and the elution of transition metal from the positive electrode active material can be effectively suppressed. The inorganic phosphate compound may be at least one ammonium phosphate.

In the above-described aspect, the inorganic phosphate compound may be a phosphate having a standard enthalpy of formation (ΔHf) of −2000 kJ/mol or higher in a standard state, the standard state being defined as a temperature of 298.15 K and a pressure of 10⁵ Pa. The present inventor found that there is a strong correlation between the elution of transition metal from the positive electrode active material and the standard enthalpy of formation. In particular, it was found that the elution of transition metal from the positive electrode active material in a high-voltage state can be significantly reduced by using a phosphate having a standard enthalpy of formation of −2000 kJ/mol or higher. Therefore, with the above-described configuration, capacity deterioration caused by the elution of transition metal from the positive electrode active material can be suppressed.

A content of the inorganic phosphate compound in the positive electrode active material layer may be less than 10 wt % relative to 100 wt % of a content of the positive electrode active material. In other words, a content of the inorganic phosphate compound in the positive electrode active material layer may be less than 10 wt % of a content of the positive electrode active material. With the above-described configuration, a qualitative influence caused by the addition of the inorganic phosphate compound, for example, an increase in resistance can be suppressed.

The high-potential positive electrode active material may be a spinel-type positive electrode active material containing Li, Ni, and Mn as essential elements. The spinel-type positive electrode active material may be LiNi_{0.5}Mn_{1.5}Mn_{1.5}O₄. The spinel-type positive electrode active material (LiNi_{0.5}Mn_{1.5}O₄) has high heat stability and high electrical conductivity and thus can be appropriately used from the viewpoints of battery performance and durability.

### BRIEF DESCRIPTION OF THE DRAWINGS

Features, advantages, and technical and industrial significance of exemplary embodiments of the invention will be described below with reference to the accompanying drawings, in which like numerals denote like elements, and wherein:

FIG. 1 is a perspective view schematically showing the external appearance of a lithium ion secondary battery according to an embodiment of the invention;

FIG. 2 is a sectional view schematically showing a sectional structure taken along line II-II of FIG. 1;

FIG. 3 is a graph showing a relationship between an inorganic phosphate compound and the elution amount of transition metal;

FIG. 4 is a graph showing the standard enthalpy of formation and the elution amount of transition metal; and

FIG. 5 is a graph showing a relationship between the addition amount of (NH₄)H₂PO₄ and the initial IV resistance.

### DETAILED DESCRIPTION OF EMBODIMENTS

Embodiments of the invention will be described. Matters necessary to implement the embodiments of the invention other than those specifically referred to in this specification may be understood as design matters based on the related art in the pertinent field for a person of skilled in the art. The invention can be implemented based on the contents disclosed in this specification and common technical knowledge in the subject field. In the following drawings, parts or portions having the same functions are represented by the same reference numerals, and the repeated description will not be made or will be simplified. In each drawing, a dimensional relationship (for example, length, width, or thickness) does not reflect the actual dimensional relationship.

Hereinafter, a lithium ion secondary battery 100 (hereinafter, also referred to simply as “battery”) according to an embodiment of the invention will be described.

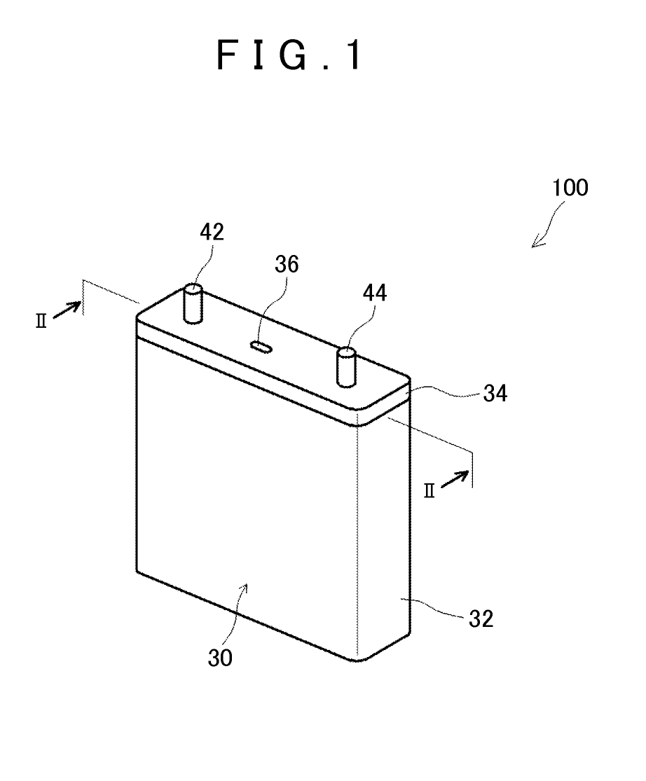

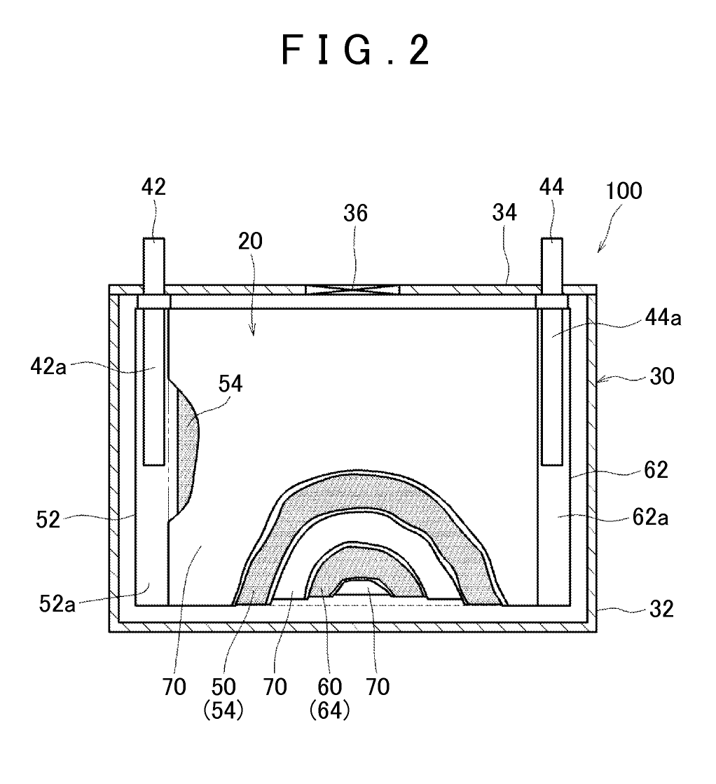

FIG. 1 is a diagram showing the external appearance of the battery (cell) 100 according to the embodiment. FIG. 2 is a sectional view schematically showing an internal structure of a battery case 30 according to the embodiment.

As shown in FIGS. 1 and 2, the lithium ion secondary battery 100 is a so-called rectangular battery 100 having a configuration in which a flat wound electrode body 20 and a nonaqueous electrolyte (not shown) are accommodated in a flat rectangular battery case (that is, an external case) 30. The battery case 30 includes a box-shaped (that is, a bottomed rectangular parallelepiped-shaped) case body 32 having an opening at an end (corresponding to an upper end in a normal operating state of the battery); and a lid 34 that seals the opening of the case body 32. As the material of the battery case 30, for example, a light-weight and highly thermally conductive metal material such as aluminum, stainless steel, or nickel-plated steel may be used.

As shown in FIGS. 1 and 2, a positive electrode terminal 42 and a negative electrode terminal 44 for external connection, a thin safety valve 36, and an injection hole (not shown) for the injection of a nonaqueous electrolyte (nonaqueous electrolytic solution) are provided on the lid 34. The safety valve 36 is set to release an internal pressure of the battery case 30 when the internal pressure increases to be a predetermined level or higher. The battery case 30 of the lithium ion secondary battery 100 may have other well-known shapes in addition to the rectangular shape (box shape) as shown in the drawings. Examples of the battery case with the other shape include a cylindrical-shaped battery case, a coin-shaped battery case, and a laminate type battery case. Among these, an appropriate case shape can be selected.

As shown in FIG. 2, the wound electrode body 20 accommodated in the battery case 30 is formed in a flat shape in which a stacked body is wound in a longitudinal direction. In the stacked body, a positive electrode 50 and a negative electrode 60 are stacked with two elongated separators 70 interposed therebetween. In the positive electrode 50, a positive electrode active material layer 54 is formed on a single surface or each of both surfaces (herein, each of both surfaces) of an elongated positive electrode current collector 52 such that the positive electrode active material layer 54 extends in the longitudinal direction. In the negative electrode 60, a negative electrode active material layer 64 is formed on a single surface or each of both surfaces (herein, each of both surfaces) of an elongated negative electrode current collector 62 such that the negative electrode active material layer 64 extends in the longitudinal direction. In addition, the flat wound electrode body 20 is formed in a flat shape, for example, by winding the stacked body in the longitudinal direction to obtain a wound body and squashing the wound body from the side surface thereof. The positive electrode current collector 52 constituting the positive electrode 50 is formed of, for example, aluminum foil. On the other hand, the negative electrode current collector 62 constituting the negative electrode 60 is formed of, for example, copper foil.

As shown in FIG. 2, a winding core portion (that is, the stacked structure in which the positive electrode active material layer 54 of the positive electrode 50, the negative electrode active material layer 64 of the negative electrode 60, and the separators 70 are stacked) is formed in the center of the wound electrode body 20 in a winding axial direction. In addition, at opposite end portions of the wound electrode body 20 in the winding axial direction, a part of a positive electrode active material layer non-forming portion 52a and a part of a negative electrode active material layer non-forming portion 62a protrude from the winding core portion to the outside, respectively. A positive electrode current collector plate 42a is attached to the protrusion on the positive electrode side (the positive electrode active material layer non-forming portion 52a). A negative electrode current collector plate 44a is attached to the protrusion on the negative electrode side (the negative electrode active material layer non-forming portion 62a). The positive electrode current collector plate 42a and the negative electrode current collector plate 44a are electrically connected to the positive electrode terminal 42 and the negative electrode terminal 44, respectively.

The positive electrode active material layer 54 according to the embodiment contains a positive electrode active material as a major component and an inorganic phosphate compound. As the positive electrode active material, one material or two or more materials selected from among materials which are conventionally used for a lithium ion secondary battery may be used without any particular limitation. Examples of the positive electrode active material include oxides (lithium transition metal composite oxides) containing lithium and a transition metal element as constituent metal elements, such as lithium nickel composite oxide (for example, LiNiO₂), lithium cobalt composite oxide (for example, LiCoO₂), and lithium manganese composite oxide (for example, LiMn₂O₄); and phosphates containing lithium and a transition metal element as constituent metal elements, such as lithium manganese phosphate (LiMnPO₄) and lithium iron phosphate (LiFePO₄). Among these, a lithium manganese composite oxide having a spinel structure represented by the following formula LiₚMn_{2-q}M_{q}O_{4+α} is preferable. In the formula, p satisfies 0.9≦p≦1.2; q satisfies 0≦q<2 (typically 0≦q≦1; for example 0.2≦q≦0.6); and α is a value which is determined so as to satisfy a charge neutral condition when −0.2≦α≦0.2 is satisfied. When q is more than 0 (0<q), M may be one element or two or more elements selected from arbitrary metal elements other than Mn and non-metal elements. More specifically, for example, M may be selected from Na, Mg, Ca, Sr, Ti, Zr, V, Nb, Cr, Mo, Fe, Co, Rh, Ni, Pd, Pt, Cu, Zn, B, Al, Ga, In, Sn, La, W, and Ce. Among these, at least one of transition metal elements such as Fe, Co, and Ni can be preferably used. Specific examples of the positive electrode active material include LiMn₂O₄ and LiCrMnO₄. It is preferable that the positive electrode active material should be a spinel-type positive electrode active material containing Li, Ni, and Mn as essential elements. More specifically, for example, the positive electrode active material may be a lithium nickel manganese composite oxide having a spinel structure represented by the following formula Liₓ(Ni_{y}Mn_{2-y-z}M1_{z})O_{4+β}. In the formula, M1 may not be present or may be an arbitrary transition metal element or a typical metal element (for example, one element or two or more elements selected from Fe, Co, Cu, Cr, Zn, and Al) other than Ni and Mn. It is preferable that M1 should contain at least one of Fe and Co both of which are trivalent. Alternatively, M1 may be a metalloid element (for example, one element or two or more elements selected from B, Si, and Ge) or a non-metal element. In addition, x satisfies 0.9≦x≦1.2; y satisfies 0<y; z satisfies 0≦z; y+z<2 (typically, y+z≦1) is satisfied; and β may have the same definition as cc described above. In a preferred example, y satisfies 0.2≦y≦1.0 (more preferably 0.4≦y≦0.6; for example, 0.45≦y≦0.55); and z satisfies 0≦z<1.0 (for example, 0≦z≦0.3). As a particularly preferable specific example, the positive electrode active material may be LiNi_{0.5}Mn_{1.5}O₄. This positive electrode active material is a high-potential positive electrode active material capable of causing an open-circuit voltage (OCV) to be 4.3 V or higher with respect to lithium metal (vs. Li/Li⁺) and thus is preferable as the positive electrode active material according to the embodiment of the invention. Further, the spinel-type positive electrode active material (for example, LiNi_{0.5}Mn_{1.5}O₄) has high heat stability and high electrical conductivity and thus can be preferably used from the viewpoints of battery performance and durability.

As the positive electrode active material, for example, lithium transition metal composite oxide powder prepared using a well-known method can be used as it is. The positive electrode active material powder is not particularly limited, but lithium transition metal composite oxide powder which is substantially formed of secondary particles having a particle size of 1 μm to 25 μm (typically, 2 μm to 10 μm; for example, 6 μm to 10 μm) can be preferably used as the positive electrode active material, the particle size corresponding to a cumulative value of 50% (median size). In this specification, unless specified otherwise, “particle size” refers to a median size in a volume particle size distribution obtained using a general laser diffraction particle size distribution analyzer.

The positive electrode active material layer 54 may further contain components other than the positive electrode active material as the above-described major component, for example, a conductive material and a binder. As the conductive material, for example, a carbon material such as carbon black (for example, acetylene black (AB)) or graphite may be preferably used. As the binder, for example, polyvinylidene fluoride (PVdF) may be used.

The lithium ion secondary battery disclosed herein has a feature that the positive electrode active material layer contains an inorganic phosphate compound. The inorganic phosphate compound may be a phosphate compound containing at least one hydrogen atom in a chemical formula. Examples of the inorganic phosphate compound include orthophosphoric acid (H₃PO₄), pyrophosphoric acid (H₄P₂O₇), and salts thereof. For example, a sodium salt (Na₂P₄O₇) or a potassium salt (K₄P₂O₇) of the acids may be used. Typically, various inorganic phosphates, for example, (NH₄)₃PO₄, (NH₄)₂HPO₄, (NH₄)H₂PO₄, (NH₄)M₂PO₄, (NH₄)MPO₄, M₂HPO₄, and MH₂PO₄ (in the formulae, M represents an alkali metal or an alkali earth metal such as Li, Na, K, Mg, or Ca) may be used. Among these, a compound that does not contain the metal atom M in a chemical formula is preferable. In particular, an ammonium phosphate that does not contain a metal atom is preferable (for example, (NH₄)₃PO₄, (NH₄)₂HPO₄, or (NH₄)H₂PO₄ is preferable). In particular, (NH₄)H₂PO₄ is preferable as the phosphate.

The inorganic phosphate compound (typically, the above-described inorganic phosphate) has high voltage resistance and thus stably functions as an acid consuming material at the open-circuit voltage of the battery according to the embodiment. Further, the inorganic phosphate compound contains a hydrogen atom and thus is highly reactive with an acid. Therefore, the consumption of an acid in the electrolyte can be increased. Accordingly, the elution of transition metal from the positive electrode active material can be suppressed, and capacity deterioration caused by the elution of transition metal can be suppressed.

In addition, the standard enthalpy of formation of the inorganic phosphate compound in the standard state (298.15 K, 10⁵ Pa) is preferably −2000 kJ/mol or higher. There is a strong correlation between the elution of transition metal from the positive electrode active material and the standard enthalpy of formation. In particular, the inorganic phosphate compound having a standard enthalpy of formation of −2000 kJ/mol or higher can significantly decrease the elution of transition metal from the positive electrode active material. Accordingly, the elution of transition metal from the positive electrode active material can be suppressed, and capacity deterioration caused by the elution of transition metal can be further suppressed.

The content of the inorganic phosphate compound contained in the positive electrode active material layer is less than 10 wt % relative to 100 wt % of the content of the positive electrode active material contained in the positive electrode active material layer (the content of the inorganic phosphate compound contained in the positive electrode active material layer is less than 10 wt % of the content of the positive electrode active material contained in the positive electrode active material layer). The content of the inorganic phosphate compound is preferably 0.1 wt % to 5 wt % (i.e., the content of the inorganic phosphate compound is preferably equal to or higher than 0.1 wt %, and equal to or lower than 5 wt %) and more preferably 0.5 wt % to 3 wt % (i.e., more preferably the content of the inorganic phosphate compound is equal to or higher than 0.5 wt %, and equal to or lower than 3 wt %). According to the above-described mixing ratio, an increase in battery resistance caused by the addition of the inorganic phosphate compound component can be suppressed. The state where the inorganic phosphate compound is present in the positive electrode active material layer is not particularly limited. The positive electrode active material (particles) may be coated with the inorganic phosphate compound (i.e., the inorganic phosphate compound may adhere to the positive electrode active material (particles)). Alternatively, the inorganic phosphate compound may be dispersed in the positive electrode active material layer without being attached to the positive electrode active material particles. It is preferable that the inorganic phosphate compound should be present in a state where the inorganic phosphate compound is substantially uniformly dispersed in the positive electrode active material layer. According to the configuration, the elution of a transition metal component can be suppressed in the entire region of the positive electrode active material layer 54.

The positive electrode active material layer 54 can be suitably manufactured, for example, using the following method. First, the above-described positive electrode active material (for example, LiNi_{0.5}Mn_{1.5}O₄ which is the high-potential positive electrode active material), an appropriate kind of inorganic phosphate compound (for example, (NH₄)H₂PO₄), and other optional material(s) (for example, the binder and/or the conductive material) are dispersed in an appropriate solvent (when PVdF is used as the binder, N-methyl-2-pyrrolidone (NMP) is preferable) to prepare a paste (slurry) composition. Next, an appropriate amount of the composition is applied to a surface of the positive electrode current collector 52 and then is dried to remove the solvent. As a result, the positive electrode active material layer 54 having desired characteristics can be formed on the positive electrode current collector 52. In addition, by performing an appropriate pressing process as necessary, the characteristics (for example, the average thickness, the active material density, the porosity of the active material layer) of the positive electrode active material layer 54 can be adjusted.

The negative electrode active material layer 64 contains at least a negative electrode active material. As the negative electrode active material, for example, a carbon material such as graphite, hard carbon, or soft carbon may be used. The negative electrode active material layer 64 may further contain a component or components other than the active material, for example, a binder or a thickener. As the binder, for example, styrene-butadiene rubber (SBR) may be used. As the thickener, for example, carboxymethyl cellulose (CMC) may be used.

The negative electrode active material layer 64 can be manufactured, for example, using a method similar to the method for manufacturing the positive electrode 50. That is, the negative electrode active material and other optional material(s) are dispersed in an appropriate solvent (for example, ion exchange water) to prepare a paste (slurry) composition. Next, an appropriate amount of the composition is applied to a surface of the negative electrode current collector 62 and then is dried to remove the solvent. As a result, the negative electrode active material layer 64 can be formed on the negative electrode current collector 62. In addition, by performing an appropriate pressing process as necessary, the characteristics (for example, the average thickness, the active material density, the porosity of the active material layer) of the negative electrode active material layer 64 can be adjusted.

Examples of the separator 70 include a porous sheet (film) formed of a resin such as polyethylene (PE), polypropylene (PP), polyester, cellulose, or polyamide. The porous sheet may have a single-layer structure or a stacked structure including two or more layers (for example, a three-layer structure in which a PE layer is provided on each of both surfaces of a PP layer).

In the nonaqueous electrolyte, typically, an organic solvent (nonaqueous solvent) may contain a predetermined supporting electrolyte and predetermined additives.

As the nonaqueous solvent, various organic solvents which can be used in an electrolyte of a general lithium ion secondary battery, for example, carbonates, ethers, esters, nitriles, sulfones, and lactones can be used without any limitation. Specific examples of the nonaqueous solvent include ethylene carbonate (EC), propylene carbonate (PC), diethyl carbonate (DEC), dimethyl carbonate (DMC), and ethyl methyl carbonate (EMC). Among these nonaqueous solvents, one kind can be used alone, or two or more kinds can be appropriately used in combination. Alternatively, fluorine-based solvents, for example, fluorinated carbonates such as monofluoroethylene carbonate (MFEC), difluoroethylene carbonate (DFEC), and trifluoro dimethyl carbonate (TFDMC) can be preferably used. For example, a mixed solvent containing MFEC and TFDMC at a volume ratio of 1:2 to 2:1 (for example, 1:1) has high oxidation resistance and thus can be preferably used in combination with a high-potential electrode.

As the supporting electrolyte, for example, a lithium salt such as LiPF₆, LiBF₄, or LiClO₄ can be preferably used. Among these, for example, LiPF₆ is particularly preferably used. The concentration of the supporting electrolyte is preferably 0.7 mol/L to 1.3 mol/L (i.e., the concentration of the supporting electrolyte is preferably equal to or higher than 0.7 mol/L, and equal to or lower than 1.3 mol/L) and is more preferably about 1.0 mol/L.

The nonaqueous electrolyte may further contain an optional component or optional components other than the nonaqueous solvent and the supporting electrolyte as long as the effects of the invention do not deteriorate. The optional component(s) is/are used for one or two or more of the purposes including improvement of battery output performance, improvement of storability (prevention of a decrease in capacity during storage), and improvement of initial charge-discharge efficiency. Examples of the optional component include a gas producing agent such as biphenyl (BP) or cyclohexylbenzene (CHB); and various additives, for example, a film forming agent such as an oxalato complex compound containing a boron atom and/or a phosphorus atom, vinylene carbonate (VC), or fluoroethylene carbonate (FEC), a dispersant, and a thickener.

The lithium ion secondary battery 100 disclosed herein can be used for various purposes. For example, the lithium ion secondary battery 100 can be preferably used as a driving power supply mounted in a vehicle such as a plug-in hybrid vehicle (PHV), a hybrid vehicle (HV), or an electric vehicle (EV).

Hereinafter, test examples relating to the invention will be described. However, the descriptions of these test examples are not intended to limit the technical scope of the invention.

### Example 1

In order to prepare a positive electrode mixture, a spinel-type positive electrode active material containing an inorganic phosphate, acetylene black (conductive material), and PVdF (binder) were mixed with each other such that a weight ratio thereof was 89:8:3. The obtained mixture was dissolved in NMP as a solvent to prepare a slurry composition. The spinel-type positive electrode active material used herein was LiNi_{0.5}Mn_{1.5}O₄ and had a particle size of 13 μm. The inorganic phosphate was (NH₄)H₂PO₄ and was added such that the amount of the inorganic phosphate was 1.0 wt % relative to 100 wt % of the amount of the positive electrode active material (i.e., such that the amount of the inorganic phosphate was 1.0 wt % of the amount of the positive electrode active material). This positive electrode mixture slurry was applied to aluminum foil (positive electrode current collector) having a thickness of 15 μm, and was dried to form a positive electrode active material layer thereon. Then, roll pressing was performed, and thus, a positive electrode was manufactured. This positive electrode was cut into a 5 cm×5 cm square with a belt-shaped portion that has a width of 10 mm and protrudes from a corner of the square. The active material layer was removed from the belt-shaped portion to expose the aluminum foil. As a result, a terminal portion was formed, and a positive electrode provided with the terminal portion was obtained.

In order to prepare a negative electrode mixture, graphite (negative electrode active material; average particle size: 20 μm, graphitization degree 0.9), CMC (thickener), and SBR (binder) were mixed with each other such that a weight ratio thereof was 98:1:1. The obtained mixture was dissolved in water as a solvent to prepare a slurry. This negative electrode mixture slurry was applied to copper foil (negative electrode current collector) having a thickness of 10 μm, and was dried to form a negative electrode active material layer thereon. Then, roll pressing was performed, and thus, a negative electrode was manufactured. This negative electrode was processed to have the same size and the same shape as those of the positive electrode provided with the terminal portion. As a result, a negative electrode provided with the terminal portion was obtained.

LiPF₆ was dissolved in a mixed solvent containing MFEC and TFDMC at a volume ratio of 1:1 such that the concentration thereof was 1 mol/L. As a result, a nonaqueous electrolyte was prepared.

A separator (porous PE/PP/PE three-layer sheet) having an appropriate size was cut out and was impregnated with the nonaqueous electrolyte. The positive electrode provided with the terminal portion and the negative electrode provided with the terminal portion were stacked with the separator interposed therebetween and were covered with a laminate film. The nonaqueous electrolyte was further injected into the laminate film, and the film was sealed. As a result, a laminate cell type battery was constructed.

### Example 2

A laminate cell type battery was constructed using the same method as that of Example 1, except that (NH₄)₂HPO₄ was used as the phosphate instead of (NH₄)H₂PO₄.

### Example 3

A laminate cell type battery was constructed using the same method as that of Example 1, except that (NH₄)₃PO₄ was used as the phosphate instead of (NH₄)H₂PO₄.

### Example 4

A laminate cell type battery was constructed using the same method as that of Example 1, except that Na₂HPO₄ was used as the phosphate instead of (NH₄)H₂PO₄.

### Example 5

A laminate cell type battery was constructed using the same method as that of Example 1, except that LiH₂PO₄ was used as the phosphate instead of (NH₄)H₂PO₄.

### Example 6

A laminate cell type battery in which the positive electrode active material layer did not contain an inorganic phosphate was constructed using the same method as that of Example 1, except that a phosphate was not used.

### Example 7

A laminate cell type battery was constructed using the same method as that of Example 1, except that Mg₃(PO₄)₂ was used as the phosphate instead of (NH₄)H₂PO₄.

### Example 8

A laminate cell type battery was constructed using the same method as that of Example 1, except that Na₂P₄O₇ was used as the phosphate instead of (NH₄)H₂PO₄.

### Conditioning Process

The battery cell in each of Examples 1 to 8 was restrained in a state where the battery cell was interposed between two plates under a load of 350 kgf (350 kg/25 cm²). The restrained battery cell was charged to 4.9 V at a constant current at a rate of 1/3 C, and the operation was stopped for 10 minutes. Then, the battery cell was discharged to 3.5 V at a constant current at a rate of 1/3 C, and the operation was stopped for 10 minutes. These operations were repeated three times. In the following measurements, the restrained battery cell was used unless specified otherwise.

### Durability Test (Elution Amount of Transition Metal)

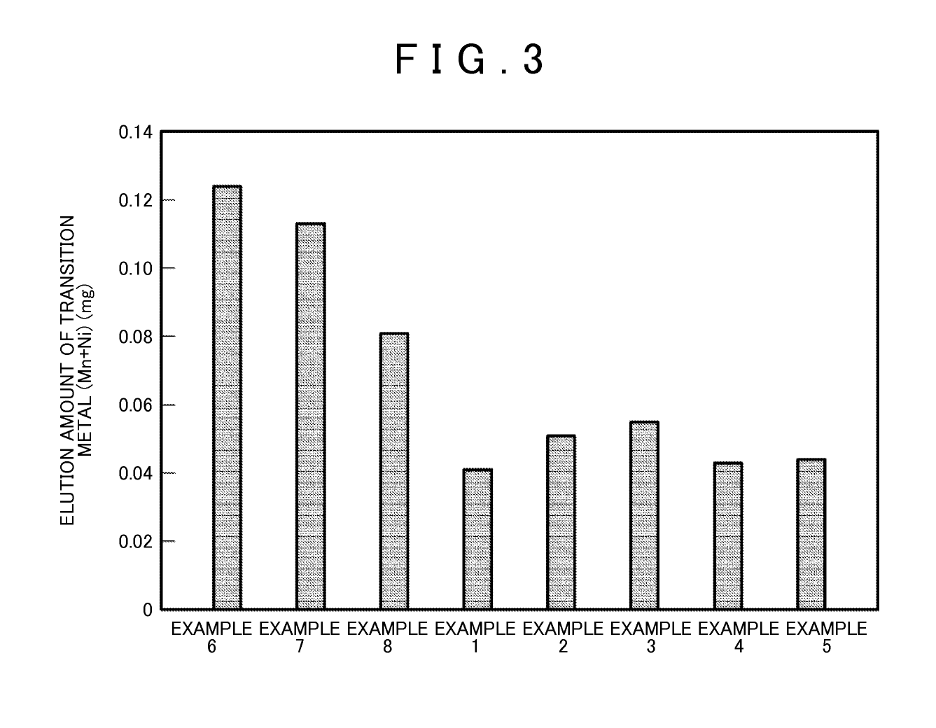

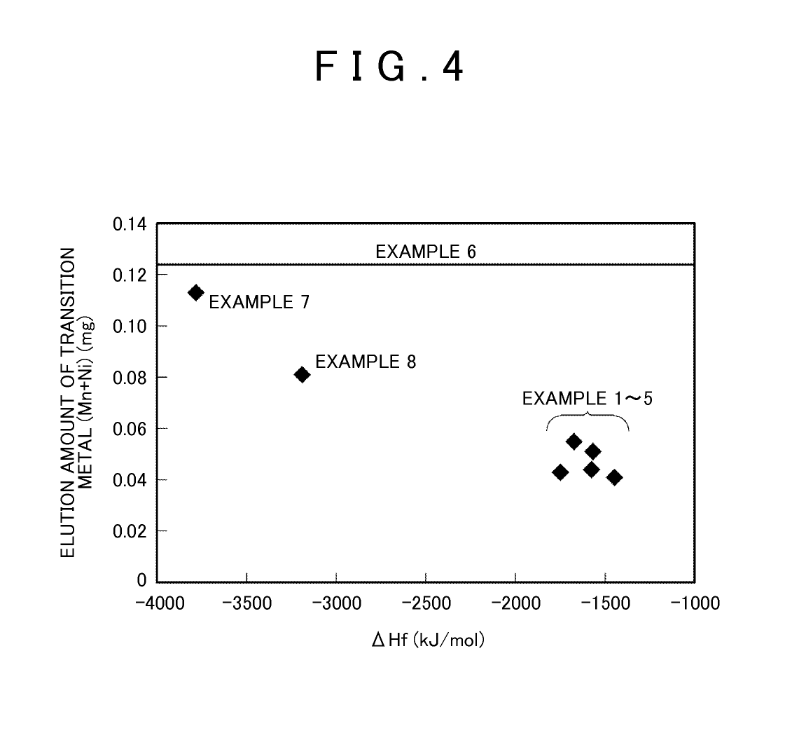

After the conditioning process, in a temperature environment of 60° C., the battery cell in each example was charged to 4.9 V at a constant current at a rate of 2 C and then was discharged to 3.5 V at a constant current at a rate of 2 C. These operations were repeated 200 times to perform a test. After this durability test, the negative electrode 60 was extracted from the battery in each example, the amount of metal deposited on the negative electrode was calculated using inductively-coupled plasma (ICP) emission spectrometry, and the calculated value was regarded as the elution amount of transition metal from the positive electrode active material. The obtained elution amount of transition metal (total amount of Ni+Mn) of each cell is shown in Table 1 and FIGS. 3 and 4. With regard to ΔHf (kJmol⁻¹) in Table 1, the values described in the document (A. La Iglesia, Estudios Geologicos 65 (2) (2009), 109) are shown for reference.

TABLE 1

| | | Elution Amount (mg) of | |
|---|---|---|---|
| | | Transition Metal | |
| Example | Phosphate | (Ni + Mn) | ΔHf (kJmol⁻¹) |
| 1 | (NH₄)H₂PO₄ | 0.041 | −1445 |
| 2 | (NH₄)₂HPO₄ | 0.051 | −1567 |
| 3 | (NH₄)₃PO₄ | 0.055 | −1672 |
| 4 | Na₂HPO₄ | 0.043 | −1748 |
| 5 | LiH₂PO₄ | 0.044 | −1574 |
| 6 | None | 0.124 | — |
| 7 | Mg₃(PO₄)₂ | 0.113 | −3781 |
| 8 | Na₂P₄O₇ | 0.081 | −3188 |

As shown in Table 1 and FIG. 3, it was found that, in the batteries of Examples 1 to 5, 7, and 8 in each of which the phosphate was added to the positive electrode active material, the elution amount of metal after the durability test was reduced as compared to Example 6 in which an inorganic phosphate was not added to the positive electrode active material. The reason is considered to be as follows. The inorganic phosphate present in the positive electrode trapped (captured) an acid that was produced in the nonaqueous electrolytic solution in a high-voltage state such that a reaction between the positive electrode active material and the acid was suppressed.

As shown in Table 1 and FIG. 4, it was verified that there is a strong correlation between the elution amount of metal after the durability test and the standard enthalpy of formation (ΔHf) of the inorganic phosphate used. In particular, it was verified that the elution amount of metal after the durability test can be significantly decreased by the use of a phosphate having a standard enthalpy of formation (ΔHf) of −2000 kJ/mol or higher. This result shows that, as the standard enthalpy of formation of the used phosphate is higher, the reactivity with the acid is higher in an environment of the nonaqueous electrolyte battery, and the elution of metal can be more effectively reduced by adding the same amount (same addition amount) of the phosphate (an amount corresponding to 1 wt % of the amount of the positive electrode active material). In particular, as in the cases of the phosphates used in Examples 1 to 5, an inorganic phosphate compound containing hydrogen as an element tends to have high standard enthalpy of formation.

### Initial IV Resistance

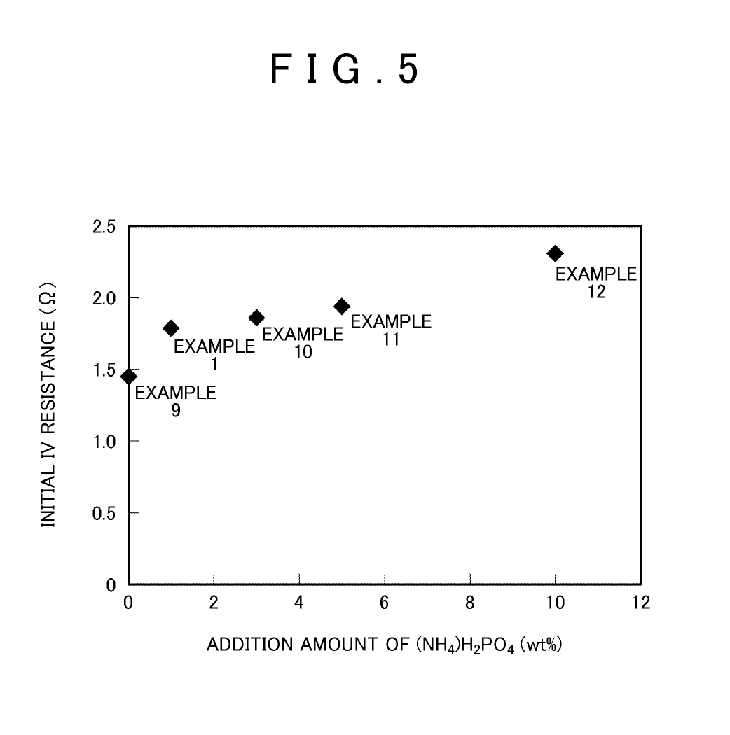

In Example 1, the battery charged to SOC 60% was discharged at a temperature of 25° C. for 10 seconds. The discharging rate was 5C. A difference (change) in voltage before and after discharging was measured. Based on the current discharging rate and the difference in voltage, the IV resistance (internal resistance) was calculated as an initial IV resistance. Table 2 and FIG. 5 show a relationship between the addition amount of (NH₄)H₂PO₄ and the initial IV resistance.

TABLE 2

| | Addition Amount (wt %) of | |
|---|---|---|
| Example | (NH₄)H₂PO₄ | Initial IV Resistance (Ω) |
| 1 | 1 | 1.79 |
| 9 | 0 | 1.45 |
| 10 | 3 | 1.86 |
| 11 | 5 | 1.94 |
| 12 | 10 | 2.31 |

In the positive electrode in Example 11, the phosphate ((NH₄)H₂PO₄) was added to the positive electrode active material layer such that the amount of the phosphate ((NH₄)H₂PO₄) was 5 wt % relative to 100 wt % of the content of the positive electrode active material. As shown in Table 2, in Example 11, the initial IV resistance was decreased to be lower than that of Example 12 and was lower than 2Ω. It is considered that, when the addition amount of the phosphate is 10 wt % or higher, the intercalation and deintercalation of lithium ions are hindered, which causes a significant increase in resistance.

Hereinabove, the invention has been described in detail, but the above-described embodiments and examples are merely exemplary. The invention disclosed herein includes various modifications and alternations of the above-described specific examples.

What is claimed is:

1. A lithium ion secondary battery comprising:
a positive electrode that includes a positive electrode active material layer;
a negative electrode that includes a negative electrode active material layer; and
a nonaqueous electrolyte, wherein:
the positive electrode active material layer contains an inorganic phosphate compound and a high-potential positive electrode active material that causes an open-circuit voltage to be 4.3 V or higher with respect to lithium metal; and
the inorganic phosphate compound is a compound containing at least one hydrogen atom in a chemical formula.

2. The lithium ion secondary battery according to claim 1, wherein the inorganic phosphate compound consists of only non-metal elements.

3. The lithium ion secondary battery according to claim 1, wherein the inorganic phosphate compound is at least one ammonium phosphate.

4. The lithium ion secondary battery according to claim 1, wherein the inorganic phosphate compound is a phosphate having a standard enthalpy of formation of −2000 kJ/mol or higher in a standard state, the standard state being defined as a temperature of 298.15K and a pressure of 10⁵ Pa.

5. The lithium ion secondary battery according to claim 1, wherein a content of the inorganic phosphate compound in the positive electrode active material layer is less than 10 wt % relative to 100 wt % of a content of the positive electrode active material.

6. The lithium ion secondary battery according to claim 1, wherein the high-potential positive electrode active material is a spinel-type positive electrode active material containing Li, Ni, and Mn as essential elements.

7. The lithium ion secondary battery according to claim 6, wherein the spinel-type positive electrode active material is LiNi_{0.5}Mn_{1.5}O₄.
